(19) United States
(12) Patent Application Publication
(10) Pub. No.: US 2004/0208329 A1
(43) Pub. Date: Oct. 21, 2004

(54) Condenser microphone

(76) Inventor: Masato Kitagawa, Gunma (JP)

Correspondence Address: FISH & RICHARDSON P.C., 45 ROCKEFELLER PLAZA, SUITE 2800, NEW YORK, NY, 10111, US

(21) Appl. No.: 10/782,609

(22) Filed: Feb. 19, 2004

(30) Foreign Application Priority Data
Feb. 20, 2003 (JP) P.2003-043322

(51) Int. Cl. H04R 25/00

(52) U.S. Cl. 381/175; 381/174

(57) ABSTRACT

Miniaturization and lighter weightis carried out for a condenser microphone, whereby a condenser microphone 10A of the present invention is structured to include: a semiconductor device 20A including a conductive pattern 11, a semiconductor element 12 placed on the conductive pattern 11, and a sealing resin 13 for integrally sealing the conductive pattern 11 and the semiconductor element 12; a fixed electrode layer 14 that is electrically connected to the semiconductor element 12 and that is formed on the surface of the sealing resin 13 to form one electrode of the condenser; and a vibration film 21 that is provided to be opposed to the fixed electrode layer 14 and that forms another electrode of the condenser.

### BACKGROUND OF THE INVENTION

1. Field of the Invention

The present invention relates to a condenser microphone that can be made lighter in weight and thin-shaped by allowing a fixed electrode layer of a condenser for sensing an audio signal to be provided at the surface of a semiconductor device.

2. Related Art

With reference to FIG. 16, the structure of the condenser microphone 100 will be described.

The condenser microphone 100 has been structured to allow the vibration plate 106, the fixed electrode 107, and the semiconductor device 110 to be stored in the case member 101. The vibration plate 106 and the fixed electrode 107, by inserting a spacer 103 therebetween, is separated by a fixed distance to form the condenser. The vibration plate 106 vibrates in accordance with sound from the outside to cause a change in the capacity value of this condenser. A FET is incorporated in the semiconductor device 110 so that the above capacity change in the condenser is applied to the FET gate electrode, thereby converting an audio signal to an electric signal.

Also, the condenser microphone 100 is built-in with the ring 102 for separating the vibration plate 106 and the case member 101; the spacer 103 for separating the vibration plate 106 and the fixed electrode 107; the holder 104 for storing the semiconductor device 110; and the substrate 105 that are incorporated in the case member 101.

However, in the conventional type condenser microphone 100, the vibration plate 106, the fixed electrode 107, and the semiconductor device 110 are built in the case member 101 as separate components. Consequently, this presents a limitation in a thin-shaped condenser microphone 100, wherein a problem exists in which the entire thickness increases approximately 2 mm or more.

Furthermore, the fixed electrode 107 and the semiconductor device 110 must be connected via the connected section 108, which also has prevented the condenser microphone 100 from being thin-shaped.

Furthermore, the ring 102, the spacer 103, the holder 104, and the substrate 105 cannot be said to be essential components of the structure of the condenser microphone 100. Accordingly, use of these components has prevented the condenser microphone 100 from being thin-shaped.

The present embodiment of invention was made in view of such a problem. It is a main object of the present embodiment of invention to provide a condenser microphone in which a fixed electrode is provided at the surface of a semiconductor device to allow the condenser microphone to be thin-shaped and lighter in weight.

### SUMMARY OF THE INVENTION

A condenser microphone of preferred embodiment comprising: a semiconductor device comprising: a conductive pattern; a semiconductor element placed on the conductive pattern; and a sealing resin for integrally sealing the conductive pattern and the semiconductor element; a fixed electrode layer electrically connected to the semiconductor element and provided on the surface of the sealing resin to form one electrode of a condenser; and a vibration film provided to be opposed to the fixed electrode layer to provide another electrode of the condenser.

A condenser microphone of preferred embodiment comprising: a semiconductor device comprising: a conductive pattern; a semiconductor element placed on the conductive pattern; and a sealing resin for integrally sealing the conductive pattern and the semiconductor element; a fixed electrode layer for forming one electrode of the condenser comprising a part of the conductive pattern; and a vibration film that is provided to be opposed to the fixed electrode layer to provide another electrode of the condenser.

The present embodiment of invention can provide the effects as shown below.

First, the fixed electrode layer 14 is formed on the surface of the semiconductor device 20A, thereby realizing miniaturization of the condenser microphone 10. Additionally, the fixed electrode layer 14 is electrically connected to the semiconductor element 12 via the penetrated hole 26 provided on the sealing resin 13. Thus, there is no need for additionally providing a connected section for connecting the fixed electrode layer 14 and the semiconductor element 12. Whereby a condenser microphone having a miniaturized, lighter weight and thin-shaped structure can be provided. Specifically, the overall thickness of the condenser microphone can be reduced to 1 mm or less.

Second, the fixed electrode layer 14 is provided on the surface of the sealing resin 13 for sealing the semiconductor element 12, thereby allowing the sealing resin 13 to separate from the semiconductor element 12 and the fixed electrode layer 14. Accordingly, the semiconductor element 12 and the fixed electrode layer 14 do not interfere with each other, thereby improving an S/N ratio of a signal which is outputted.

Third, the semiconductor device 20A can be directly fixed to the inner wall of the case member 25, thereby constructing the condenser microphone without a substrate for mounting the semiconductor device 20A. Accordingly, a condenser microphone that is further miniaturized and lighter in weight can be provided.

Fourth, a region in which the semiconductor element 12 is placed and a part of the conductive pattern 11 forming a bonding pad or the like are used as the fixed electrode layer 14, thereby providing a condenser microphone having a simpler structure.

### BRIEF DESCRIPTION OF THE DRAWINGS

FIG. 1A is a cross-sectional view, FIG. 1B is a plan view, and FIG. 1C is a plan view illustrating a condenser microphone of the preferred embodiment.

FIG. 2 is a circuit diagram illustrating the condenser microphone of the preferred embodiment.

FIG. 3A is a cross-sectional view and FIG. 3B is a cross-sectional view illustrating the condenser microphone of the preferred embodiment.

FIG. 4A is a cross-sectional view and FIG. 4B is a plan view illustrating the condenser microphone of the preferred embodiment.

FIG. 5 is a cross-sectional view illustrating the condenser microphone of the preferred embodiment.

FIG. 6 is a cross-sectional view illustrating a manufacturing method of the condenser microphone of the preferred embodiment.

FIG. 7 is a cross-sectional view illustrating the manufacturing method of the condenser microphone of the preferred embodiment.

FIG. 8 is a cross-sectional view illustrating the manufacturing method of the condenser microphone of the preferred embodiment.

FIG. 9 is a cross-sectional view illustrating the manufacturing method of the condenser microphone of the preferred embodiment.

FIG. 10 is a cross-sectional view illustrating the manufacturing method of the condenser microphone of the preferred embodiment.

FIG. 11 is a cross-sectional view illustrating the manufacturing method of the condenser microphone of the preferred embodiment.

FIG. 12 is a cross-sectional view illustrating the manufacturing method of the condenser microphone of the preferred embodiment.

FIG. 13 is a cross-sectional view illustrating the manufacturing method of the condenser microphone of the preferred embodiment.

FIG. 14 is a cross-sectional view illustrating the manufacturing method of the condenser microphone of the preferred embodiment.

FIG. 15 is a cross-sectional view illustrating the manufacturing method of the condenser microphone of the preferred embodiment.

FIG. 16 is a cross-sectional view illustrating the related condenser microphone.

### DESCRIPTION OF THE PREFERRED EMBODIMENTS

### Embodiment 1 for Explaining the Structure of the Condenser Microphone

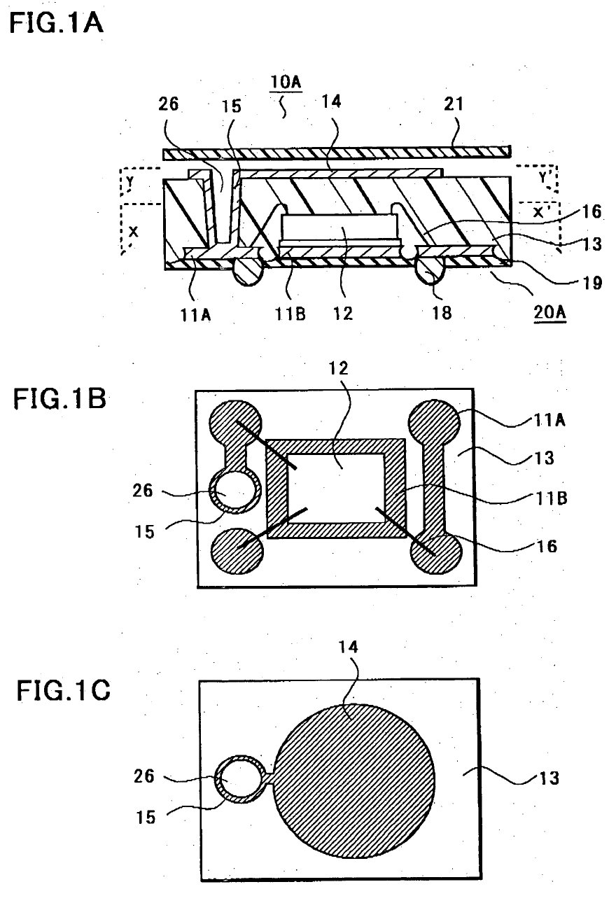

With reference to FIG. 1, the condenser microphone 10A of the preferred embodiment will be described with regards to the structure or the like. FIG. 1A is a cross-sectional view of the condenser microphone 10A. FIG. 1(B) is a plan view taken along the line X-X′ of FIG. 1A. FIG. 1C is a cross-sectional view taken along the line Y-Y′ of FIG. 1A.

With reference to FIG. 1A, the condenser microphone 10A of the preferred embodiment is structured to include: the semiconductor device 20A comprising the conductive pattern 11, the semiconductor element 12 placed on the conductive pattern 11, and the sealing resin 13 for integrally sealing the conductive pattern 11 and the semiconductor element 12; the fixed electrode layer 14 that is electrically connected to the semiconductor element 12 and that is formed at the surface of the sealing resin 13 to provide one electrode of the condenser; and the vibration film 21 that is provided to be opposed to the fixed electrode layer 14 to provide another electrode of the condenser. Hereinafter, each of these components of the structure will be described.

The conductive pattern 11 comprises metal such as copper and the back face is exposed to be buried in the sealing resin 13. The conductive pattern 11 forms the conductive pattern 11B for forming a die pad on which the semiconductor element 12 is mounted and the conductive pattern 11A being formed as a bonding pad.

With reference to FIG. 1B, the conductive pattern 11B is disposed at the center section and the upper part thereof is fixed via an adhesive agent to the circuit element 12. The back face of the conductive pattern 1A exposed from the sealing resin 13 is protected by the solder resist 19. A plurality of conductive patterns 11A are disposed at the circumference of the semiconductor device 20A so as to surround the conductive pattern 11B and are electrically connected via a thin metal wire 16 to the electrode of the semiconductor element 12. Also, in the back face of the conductive pattern 11A, the external electrode 18 consisting of a brazing material such as soldering is formed. Furthermore, one conductive pattern 11A is electrically connected via the connected section 15 provided in the penetrated hole 26 to the fixed electrode layer 14. A wiring section for connecting conductive patterns 11A also may be formed. In addition, although the conductive pattern 11 has a single layer wiring structure here, another wiring structure having two or more layers may be structured by the conductive pattern 11. This allows a more complicated circuit to be structured in the semiconductor device 20A.

The sealing resin 13 seals the entirety while the back face of the conductive pattern 11 is exposed. The sealing resin 13 seals the semiconductor element 12, the thin metal wire 16, and the conductive pattern 11. Thermosetting resin formed by a transfer molding or thermoplastic resin formed by an injection molding is generally adopted as the sealing resin 13.

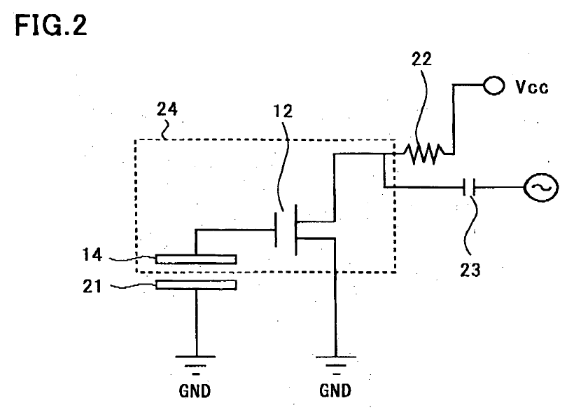

A FET is adopted as the semiconductor element 12, the gate electrode is electrically connected to the fixed electrode layer 14 via the thin metal wire 16 and the connected section 15. The source electrode and the drain electrode of the semiconductor element 12 are connected via the thin metal wire 16 to the conductive pattern 11A forming a bonding pad. This allows a capacity change in the condenser consisting of the fixed electrode layer 14 and the vibration film 21 to be converted to an electric signal by the semiconductor element 12. A specific circuit structure will be described later with reference to FIG. 2. The semiconductor element 12 also may be a semiconductor element other than a single FET. For example, an IC may be adopted as the semiconductor element 12 in which an amplifying circuit or a noise cancel circuit is constructed by integrating bipolar type and MOS type active elements and a passive element (e.g., resistance).

The penetrated hole 26 is provided by partially removing the sealing resin 13 and the surface of the conductive pattern 11A is exposed from the bottom surface of the conductive pattern 11. At the side face of this penetrated hole 26, the connected section 15 consisting of a metal film is formed, to which the fixed electrode layer 14 formed on the surface of the sealing resin 13 and the conductive pattern 11A are electrically connected. The penetrated hole 26 is formed in such a manner that the section in the planar direction is formed to be almost circular and the section in the vicinity of the surface of the sealing resin 13 is formed to be larger than the section of the lower part.

With reference to FIG. 1C, the fixed electrode layer 14 is formed of a metal such as copper and is provided on the surface of the sealing resin 13 by an electrolytic plating method or a non electric electrolytic plating method. The fixed electrode layer 14 is connected to the gate electrode of the semiconductor element 12 via the connected section 15 formed in the penetrated hole 26. The fixed electrode layer 14 and the connected section 15 also may be integrally formed with a plated film. Herein, the fixed electrode layer 14 is formed to be circular.

The vibration film 21 is provided opposing the fixed electrode layer 14 at a fixed distance to form another electrode of the condenser. A semi permanently charged resin film may be adopted as the vibration film 21. The condenser microphone adopting such a vibration film 21 is called an electret condenser microphone.

The connected section 15 is a metal layer formed on the side face and the bottom face of the penetrated hole 26 and functions to electrically connect the fixed electrode layer 14 to the conductive pattern 11A. The connected section 15 also may be formed so as to be filled into the penetrated hole 26.

The above-described fixed electrode layer 14 and the connected section 15 are integrally formed by a plating method. By the plating method, a metal layer having a uniform thickness is formed on the surface of the sealing resin 13, the side face of the penetrated hole 26, and the surface of the conductive pattern 11A. Thus, the fixed electrode layer 14 and the conductive pattern 11B are securely electrically connected with the connected section 15 integrally formed with the fixed electrode layer 14.

With reference to FIG. 2, the circuit structure of the condenser microphone 10A will be described. The region enclosed by the broken line 24 is a circuit which is built in the semiconductor device 20A. The gate electrode of the semiconductor element 12, which is a FET is electrically connected to the fixed electrode layer 14 provided on the surface of the sealing resin 13 via the thin metal wire 16 or the like. The drain electrode of the semiconductor element is connected to the power source Vcc via a resistance 22 and is outputted to the alternate current side via a coupling condenser 23. The source electrode and the vibration film 21 of the semiconductor element 12 are grounded to a GND. In the related type condenser microphone, the fixed electrode layer and the semiconductor element are separate components, however, the preferred embodiment provides a simplified structure since the fixed electrode layer 14 is provided on the surface of the sealing resin 13 sealing semiconductor element 12.

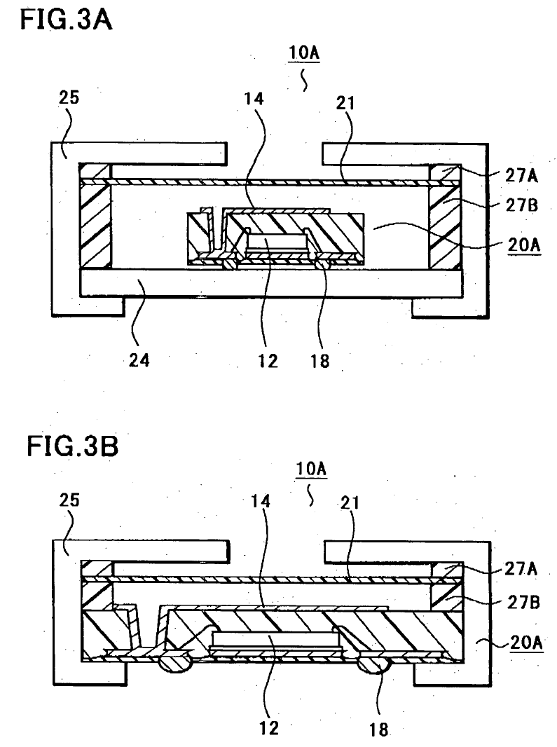

With reference to FIG. 3, the structure of the condenser microphone 10A in which the semiconductor device 20A is built in a case member 25 will be described. FIG. 3A is a cross-sectional view illustrating the condenser microphone 10A in which the semiconductor device 20A is fixed to the case member 25 via the substrate 24. FIG. 3B is a cross-sectional view illustrating the condenser microphone 10A in which the semiconductor device 20A is directly fixed to the case member 25.

With reference to FIG. 3A, the vibration film 21 constituting the condenser microphone and the semiconductor device 20A in which the fixed electrode layer 14 is fixed on the surface thereof are stored inside the case member 25. The case member 25 consists of a metal such as aluminum or a resin and the center hole penetrating the upper part allows sound to pass therethrough to the interior. In addition, the case member 25 also has a cylindrical outer shape. Thus, rings 27A and 27B, the vibration film 21, and the substrate 24 stored in the inner wall of the case member 25 have a disc-like shape.

The rings 27A and 27B are used for positioning each component constituting the condenser microphone and the center is penetrated to form a ring shape. The ring 27A functions to separate the vibration film 21 from the case member 25. The ring 27B functions to separate the vibration film 21 from the semiconductor device 20A. The fixed electrode layer 14 is formed on the upper face of the semiconductor element 12. Thus, the preferred embodiment can provide a structure in which a spacer for separating the vibration film 21 from the fixed electrode layer 14 is eliminated.

The substrate 24, at which the semiconductor device 20A is mounted on the surface thereof, functions to seal the case member 25. A conductive path which has been electrically conducted is formed on both faces of the substrate 24 and the semiconductor device 20A is mounted on the conductive path on the surface via the external electrode. The vibration film 21 and the substrate 24 are connected to the conductive path via the body of the case member 25 or a conductive pin or the like. The conductive path formed on the back face of the substrate 24 is electrically conducted to the conductive path on the surface, and a lead or a solder electrode is provided, thereby forming a connected section to the exterior.

With reference to FIG. 3B, the semiconductor device 20A is directly fixed to the inner wall of the case member 25. Specifically, FIG. 3B shows a structure in which the substrate 24 of FIG. 3A is eliminated. The semiconductor device 20A used herein has an outer circular shape so as to be engaged with the inner wall of the case member 25. The semiconductor device 20A having such a shape can be manufactured by cutting the sealing resin 13 forming the outer shape of the semiconductor device 20A into a circular shape by using a laser or the like. The structure eliminating the substrate 24 can provide a thin-shaped and simplified structure of the condenser microphone 10A.

In FIG. 3B, the semiconductor device 20A functions to seal the interior of the case member 25 and the external electrode 18 formed on the back face functions as an external terminal of the microphone 10A.

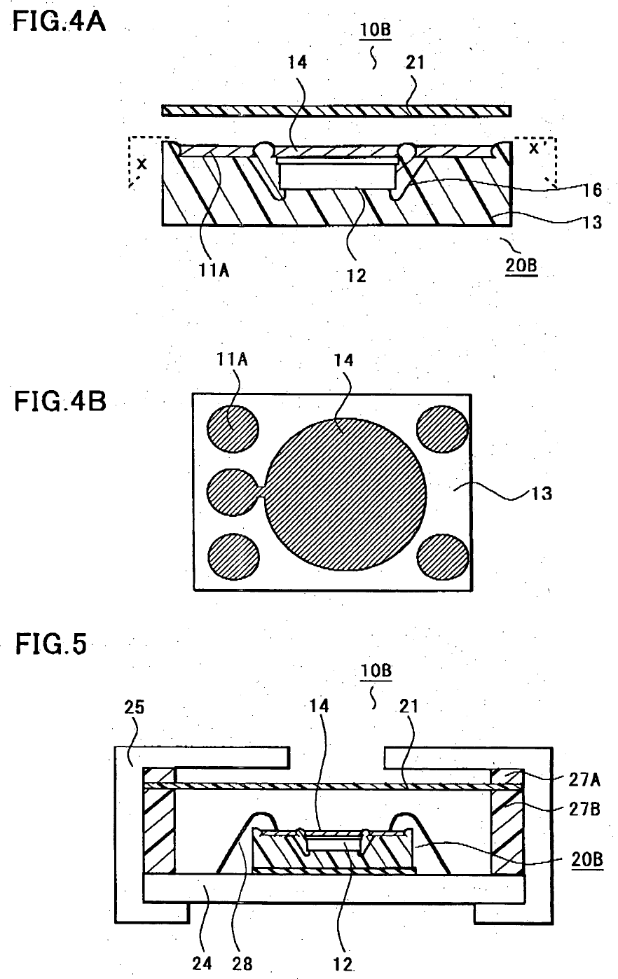

With reference to FIG. 4, the structure of the condenser microphone 10B of another embodiment-will be described. The condenser microphone 10B is structured to include: the semiconductor device 20B comprising the conductive pattern 11, the semiconductor element 12 placed on the conductive pattern 11, and the sealing resin 13 for integrally sealing the conductive pattern 11 and the semiconductor element 12; the fixed electrode layer 14 that consists of apart of the conductive pattern 11 and that forms one electrode of the condenser; and the vibration film 21 that is provided to be opposed to the fixed electrode layer 14 and that forms another electrode of the condenser. In FIG. 4, those components that are the same as those of the condenser microphone 10A shown in FIG. 1 are provided with the same reference numerals and a specific description will be omitted.

With reference to FIG. 4A, the semiconductor device 20B is placed in such a manner that the face from which the conductive pattern 11A is exposed is faced in the upward direction. The conductive pattern 11 to which the semiconductor element 21 is fixed functions as the fixed electrode layer 14. The fixed electrode layer 14 and the vibration film 21 form a condenser. The fixed electrode layer 14 and the semiconductor element 12 are electrically connected via the thin metal wire 16 and the conductive pattern 11A.

With reference to FIG. 4B, a specific configuration of the conductive pattern 11 will be described. In FIG. 4B, a round-shaped conductive pattern 11 on which the semiconductor element 12 is placed is formed on the center section and functions as the fixed electrode layer 14. Furthermore, the conductive pattern 11A connected via the built-in semiconductor element 12 and the thin metal wire 16 is provided at the periphery. One of the conductive patterns 11A is connected with the fixed electrode layer 14.

With reference to FIG. 5, the structure of the condenser microphone 10B will be described in which the semiconductor device 20B shown in FIG. 4 is built in the case member 25. The case member 25 has a cylindrical shape and the vibration film 21, and the semiconductor device 20B are built therein. As in the condenser microphone 10A shown in FIG. 3, the rings 27A and 27B are used to position each component.

The semiconductor device 20B is fixed to the substrate 24 via an insulating adhesive material such that the face from which the conductive pattern 11 is exposed is faced in the upward direction. The conductive pattern 11A is electrically connected to the conductive path formed on the surface of the substrate via the thin metal wire 28. Thus, the conductive pattern 11 has functions other than a region in which the semiconductor element 12 is placed, such as the wiring part, and the bonding pad inside the semiconductor device 20B. Specifically, the conductive pattern 11 also functions as a bonding pad of the fixed electrode layer 14 and the thin metal wire 28. Components other than the semiconductor device 20B are the same as those described for FIG. 3.

The above-described condenser microphone 10B has a structure in which the semiconductor device 20B has a simpler shape as compared to that of the semiconductor device 20A shown in FIG. 1, thus allowing a condenser microphone with lower costs.

The advantage of preferred embodiment exists in that the fixed electrode layer 14 is provided on the upper face of the sealing resin 13 so that the fixed electrode layer 14 is electrically connected to the semiconductor element 12. Specifically, the fixed electrode layer 14 consisting of a metal film is formed on the upper face of the sealing resign 13 and is electrically connected to the semiconductor element 12 via the connected section 15 provided in the penetrated hole 26. Accordingly, the gate electrode of the semiconductor element 12, which is a FET, and the fixed electrode layer 14 are electrically connected, thereby converting an audio signal to an electric signal. This can realize miniaturization and lighter weight of the condenser microphone 10A.

Further, the advantage of preferred embodiment exists in that the fixed electrode layer 14 is electrically connected to the conductive pattern 11B via the penetrated hole 26 provided by partially removing the sealing resin 13. Specifically, the connected section 15 consisting of a metal film is formed on the conductive pattern exposed from the side face and the bottom face of the penetrated hole 26. The connected section 15 and the fixed electrode layer 14 are integrally formed by the plating method or the like, thus electrically connecting the fixed electrode layer 14 and the conductive pattern 11B. This eliminates the need for adding another component for electrically connecting the fixed electrode layer 14 and the conductive pattern 11B.

Additionally, in the above description, although the conductive pattern 11 has a single layer wiring structure, the conductive pattern also may be formed to have a multilayer wiring structure. Specifically, the conductive pattern forming a plurality of layers is formed via an insulation layer and the conductive pattern of each layer is electrically connected via the connected section, thereby realizing a multilayer wiring structure.

### Embodiment 2 for Explaining the Manufacturing Method of the Circuit Apparatus 10

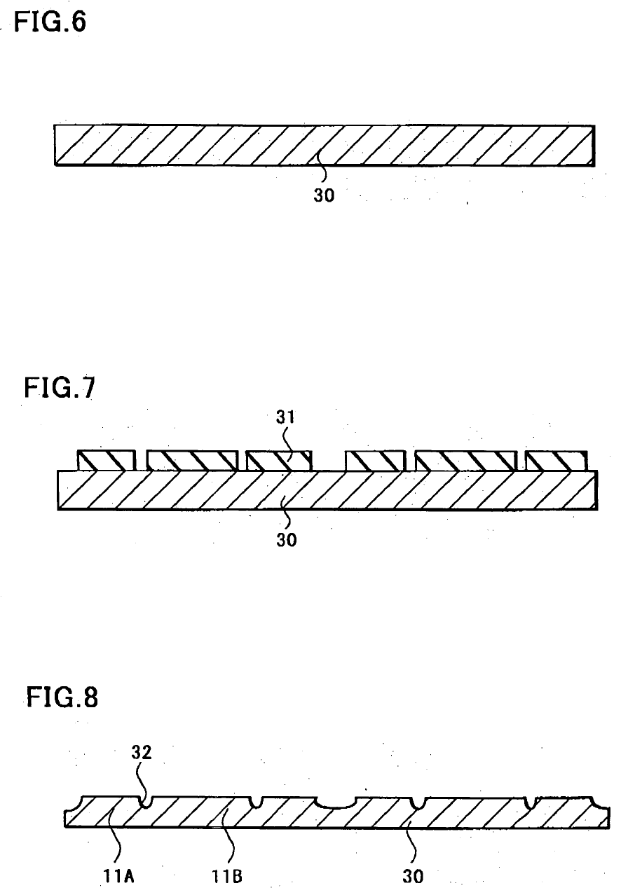

In the present embodiment, the manufacturing method of the condenser microphone 10A, mainly the manufacturing method of the semiconductor device 20A will be described. In the present embodiment, the condenser microphone 10A is manufactured by the steps as shown below. Specifically, the manufacturing method includes: a step for preparing the conductive foil 30; a step for forming the separation groove 32 that is thin-shaped than the thickness of the conductive foil 30 thereon to form a plurality of conductive patterns 11; a step for fixing the semiconductor element 12 to the conductive pattern 11; a step for coating and molding the semiconductor element 12 with the sealing resin 13 so as to be filled into the separation groove 32; a step for forming the penetrated hole 26 in the sealing resin 13 so that the conductive pattern 11 is exposed; a step for forming the fixed electrode layer 14 in the surface of the sealing resin 13 and simultaneously forming the connected section 15 at the side face and the bottom face of penetrated hole 26; a step for removing the back face of the conductive foil 30 until the sealing resin 13 is exposed; a step for dicing the sealing resin 13 to separate each circuit device; and a step for installing elements constituting the condenser microphone in the case member 25. The following sections will describe each step of the preferred embodiment with reference to FIG. 6 to FIG. 15.

Step 1: see FIG. 6 to FIG. 8.

In this step, the conductive foil 30 is prepared and the separation groove 32 thin-shaped than the thickness of the conductive foil 30 is formed on the conductive foil 30 to form a plurality of conductive patterns 11.

In this step, as shown in FIG. 6, the sheet-like conductive foil 30 is prepared. For this conductive foil 30, the material is selected in consideration of adhesion, bonding, and plating performances of a brazing material, and a conductive foil mainly consisting of Cu, a conductive foil mainly consisting of Al, or a conductive foil consisting of an alloy (e.g., Fe—Ni) is adopted. The thickness of the conductive foil is preferably approximately 10 μm to 300 μm in consideration of the subsequent etching, however, a conductive foil having a thickness of 300 μm or more or 10 μm or less may be adopted so long as the separation groove 32 has a thickness thin-shaped than that of the conductive foil 30 as described below.

Next, as shown in FIG. 7, the photoresist (etching resistant mask) 31 is formed on the conductive foil 30 and patterned so that the conductive foil 30 except for a region working as the conductive pattern 11 is exposed.

Then, with reference to FIG. 8, the conductive foil 30 is selectively etched. In FIG. 8, the conductive pattern 11 constitutes the conductive pattern 11B forming a die pad and the conductive pattern 11A constituting a bonding pad or the like. The side face of the separation groove 32 is bent to have a curved shape so as to have a strong contact with the sealing resin 13 filled in this part.

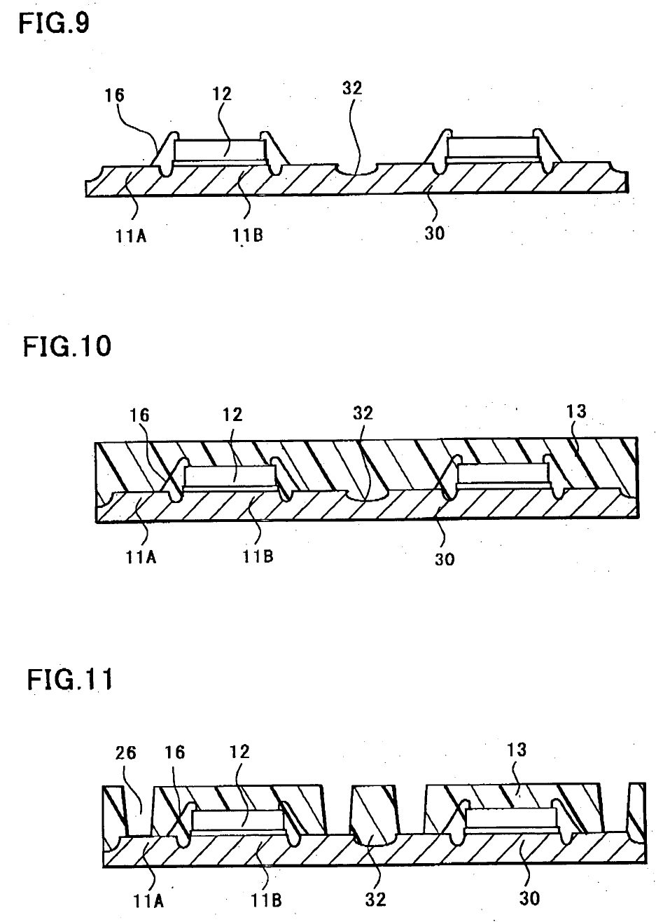

Step 2: see FIG. 9

In this step, the semiconductor element 12 is fixed to the conductive pattern 11B and the semiconductor element 12 is electrically connected to the conductive pattern 11B.

With reference to FIG. 9, the semiconductor element 12 is mounted on the conductive pattern 11B via an adhesive agent. Any insulating agent can be adopted as an adhesive agent. Furthermore, the electrode of the semiconductor element 12 is wire-bonded to the desired conductive pattern 11A. Specifically, the electrode of the semiconductor element 12 mounted on the conductive pattern 11B and the desired conductive pattern 11A are collectively wire-bonded by a ball bonding with heat pressurization and a wedge bonding with a supersonic wave.

In FIG. 9, a FET is fixed to the conductive pattern 11B as the semiconductor element 12, however, an IC may be adopted as the semiconductor element 12 in which an amplifying circuit or a noise cancel circuit is constructed by integrating a bipolar type and MOS type active elements and a passive element.

Step 3: see FIG. 10

In this step, the semiconductor element 12 is coated and molded with the sealing resin 13 so as to be filled into the separation groove 32.

In this step, as shown in FIG. 10, the semiconductor element 12 and a plurality of conductive patterns 11 are coated with the sealing resin 13 and the separation groove 32 is filled with the sealing resin 13 so as to engage and strongly adhere the separation groove 32. The conductive pattern 11 is supported by the sealing resin 13. In this step, a transfer molding, an injection molding, or a potting can be used. As a resin material, a thermosetting resin such as an epoxy resin can be used for transfer molding or a thermoplastic resin such as polyimide resin, polyphenylene sulfide etc., can be used for injection molding.

The advantage of this step exists in that the conductive foil 30 working as the conductive pattern 11 functions as a support substrate until the conductive foil 30 covers the sealing resin 13. Although a conductive pattern is formed by adopting an inherently unnecessary support substrate in the conventional art, the conductive foil 30 functioning as a support substrate is a material necessary for the electrode material. Therefore, the preferred embodiment provides an advantage that components can be reduced wherever possible and the cost can also be reduced. The separation groove 32 is formed in such a manner that the thickness is thin-shaped than that of the conductive foil, thus the conductive foil 30 is not individually separated as the conductive pattern 11. Accordingly, the conductive pattern 11 can be handled as integral sheet-like conductive foil 30 and, when the sealing resin 13 is molded, the conductive foil 30 can easily be transferred and mounted to a metal mold.

Step 4: see FIG. 11

In this step, the penetrated hole 26 is formed in the sealing resin 13 so that the conductive pattern 11 is exposed. In this step, the sealing resin 13 is partially removed to form the penetrated hole 26, thereby allowing the surface of the conductive pattern 11A to be exposed. Specifically, the sealing resin 13 is partially removed by use of a laser to form the penetrated hole 26, thereby exposing the surface of the conductive pattern 11. Herein, as a laser, a carbon dioxide gas laser is preferable. Further, when a residue exists after allowing the sealing resin 13 to evaporate by a laser, this residue is removed by wet etching with permanganic acid sodium or ammonium persulfate or the like.

The planar shape of the penetrated hole 26 formed by a laser is formed to be circular. Further, the section size of the penetrated hole 26 is smaller the closer to the bottom section of the penetrated hole 26.

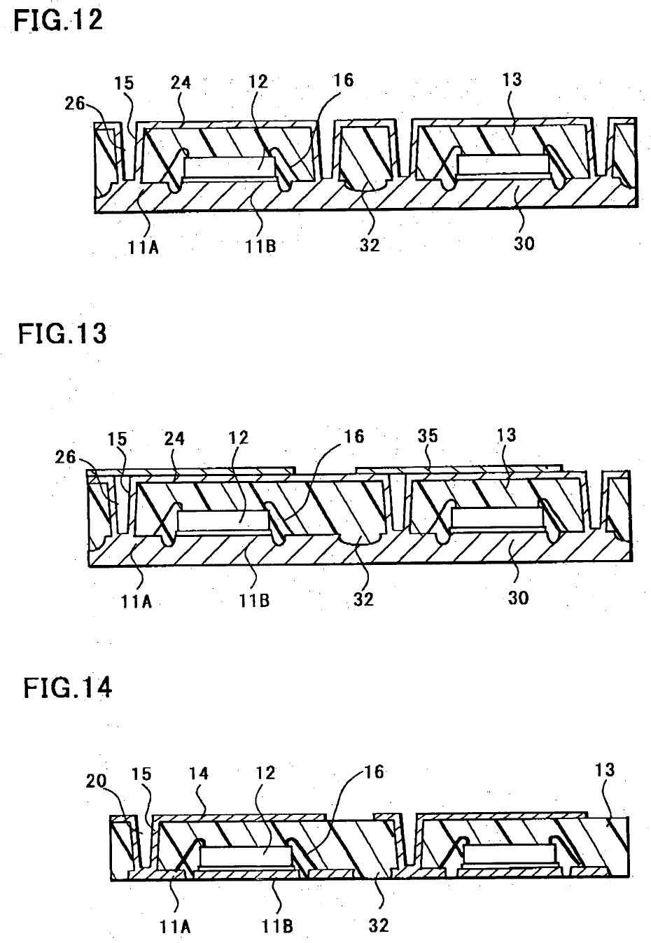

Step 5: see FIG. 12 and FIG. 13.

In this step, the fixed electrode layer 14 is formed on the surface of the sealing resin 13, simultaneously, the connected section 15 is formed on the side face and the bottom face of the penetrated hole 26.

In this step, a plated film consisting of a metal such as copper is formed on the upper face of the sealing resin 13 and on the side face of the penetrating hole 26 by an electrolytic plating method or a non electrolytic plating method to form the fixed electrode layer 14 and the connected section 15. In a case where a plated film is formed by the electrolytic plating method, the back face of the conductive foil 30 is used as an electrode. In FIG. 12, a plating film having the same thickness as that of the fixed electrode layer. 14 is formed on the side face section of the penetrated hole 26, however, the penetrated hole 26 also may be filled with a plating material. When the penetrated hole 26 is filled with a metal, then a plating fluid including an addition agent is used. Such a plating method is generally called a filling plating.

Next, with reference to FIG. 13, the fixed electrode layer 14 formed on the upper face of the sealing resin 13 is separated for each circuit apparatus 10. Specifically, first, the fixed electrode layer 14 is first covered with the resist 35 so that the fixed electrode layer 14 is formed on a part except for a portion corresponding to the border line of each circuit apparatus 10. Then, an etching is carried out to partially remove the fixed electrode layer 14 at a portion corresponding to the border line of each circuit apparatus 10. After the etching is completed, the resist 35 is peeled.

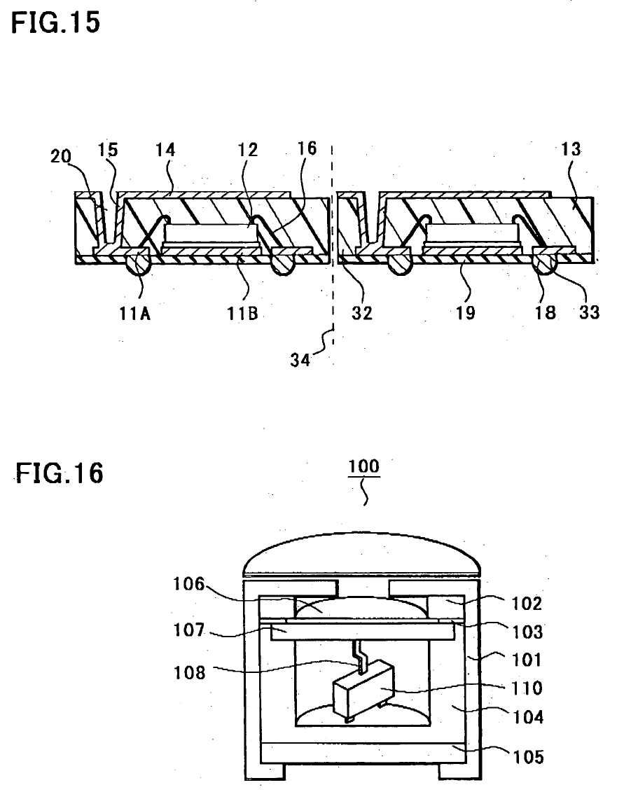

Step 6: see FIG. 14 to FIG. 15

In this step, the back face of the conductive foil 30 is removed until the back face of the sealing resin 13 is exposed. This step also may be simultaneously performed with Step 5.

With reference to FIG. 14, in this step, the back face of the conductive foil 30 is chemically or physically removed so as to separate as the conductive pattern 11. This step is carried out by polishing, grinding, etching, metal evaporation by a laser or the like. In an experiment, the conductive foil 30 is entirely subjected to wet etching so that the sealing resin 13 is exposed from the separation groove 32. As a result, the conductive pattern 11 is separated into the conductive pattern 11A and the conductive pattern 11B, and the back face of the conductive pattern 11 is exposed from the sealing resin 13. Specifically, the surface of the sealing resin 13 filled into the separation groove 32 and the surface of the conductive pattern 11 substantially correspond to each other.

Next, with reference to FIG. 15, the solder resist 19 is formed so as to cover the exposed face of the conductive pattern 11. The fixed electrode layer 14 consisting of a metal (e.g., copper) is formed on the upper face of the sealing resin 13, the conductive pattern 11 is exposed from the back face of the sealing resin 13. Thus, an opening section 33 is formed at a position at which the external electrode 18 is formed, and the back face of the sealing resin 13 is coated with the solder resist 19. This opening section 33 is formed by performing exposure and development.

Next, the external electrode 18 is formed on the back face of the conductive pattern 11 which is exposed from the opening section 33. Specifically, a brazing material such as a solder is coated on the opening section 33 by a screen printing or the like to melt the opening section 33, thereby forming the external electrode 18.

Next, the sealing resin 13 at a position corresponding to the border line of each semiconductor device is diced to divide the sealing resin 13 into an individual circuit device. The conductive foil 30 at a position corresponding to the dicing line 34 is removed by the step for etching the conductive foil of the back face. The fixed electrode layer 14 at a position corresponding to the dicing line 34 is also removed by etching. Thus, in this step, a dicing blade removes only the sealing resin 13, thus abrasion of the blade can be suppressed to a minimum.

The semiconductor device 20A manufactured by the above steps is stored in the case member 25 together with other components forming the condenser microphone. The semiconductor device 20A finally obtains a shape as shown in FIG. 3, for example.

The advantage of preferred embodiment exists in that the fixed electrode layer 14 provided on the upper face of the sealing resin 13 and the connected section 15 for electrically connecting the fixed electrode layer 14 to the conductive pattern 111 are integrally formed. Specifically, the fixed electrode layer 14 and the connected section 15 form an integrated plating film that is formed by an electrolytic plating method or a non electrolytic plating method. Thus, an increase in the number of steps due to formation of the fixed electrode layer 14 can be reduced wherever possible.

The advantage of preferred embodiment also exists in that the penetrated hole 26 is formed on the sealing resin 13 by use of a laser. Specifically, by adjusting a laser output, only the sealing resin 13 can be removed, thereby the removal by the laser can be stopped at the interface between the sealing resin 13 and the conductive pattern 11.

Further, in the above description, although the penetrated hole 26 is formed by use of a laser, the penetrated hole 26 also maybe formed by a method other than a laser. Specifically, in the step for molding the sealing resin 13, a convex section corresponding to a shape of the penetrated hole 26 is formed on a metal mold having a contact with the upper face of the sealing resin 13. Then, the tip end section of the convex section is sealed with the sealing resin 13 while contacting with the surface of the conductive pattern, thereby forming the penetrated hole 26 having a shape corresponding to that of this convex section.

What is claimed is:

1. A condenser microphone comprising:
a semiconductor device comprising: a conductive pattern; a semiconductor element placed on the conductive pattern; and a sealing resin for integrally sealing the conductive pattern and the semiconductor element;
a fixed electrode layer electrically connected to the semiconductor element and provided on the surface of the sealing resin to form one electrode of a condenser; and
a vibration film provided to be opposed to the fixed electrode layer to provide another electrode of the condenser.

2. The condenser microphone according to claim 1, wherein the fixed electrode layer is formed on the surface of the sealing resin opposing the face from which the conductive pattern is exposed.

3. The condenser microphone according to claim 2, wherein the fixed electrode layer is electrically connected via a penetrated hole provided in the sealing resin to the conductive pattern.

4. The condenser microphone according to claim 1, wherein the fixed electrode layer consists of a plating film.

5. The condenser microphone according to claim 1, wherein the sealing resin exposes the back face of the conductive pattern and coats the semiconductor element and the conductive pattern.

6. The condenser microphone according to claim 1, wherein the semiconductor device, the fixed electrode layer, and the vibration film are stored in a case member and the semiconductor device is fixed via a substrate to the inner wall of the case member.

7. The condenser microphone according to claim 1, wherein the semiconductor device, the fixed electrode layer, and the vibration film are stored in a case member and the semiconductor device is directly fixed to the inner wall of the case member.

8. A condenser microphone comprising:
a semiconductor device comprising: a conductive pattern; a semiconductor element placed on the conductive pattern; and a sealing resin for integrally sealing the conductive pattern and the semiconductor element;
a fixed electrode layer for forming one electrode of the condenser comprising a part of the conductive pattern; and
a vibration film that is provided to be opposed to the fixed electrode layer to provide another electrode of the condenser.

9. The condenser microphone according to claim 8, wherein the conductive pattern to which the semiconductor element is fixed is used as the fixed electrode layer.

10. The condenser microphone according to claim 8, wherein the sealing resin exposes the back face of the conductive pattern and covers the semiconductor element and the conductive pattern.

11. The condenser microphone according to claim 8, wherein the semiconductor device, the fixed electrode layer, and the vibration film are stored in a case member and the semiconductor device is fixed via a substrate to the inner wall of the case member.
